(19) United States
(12) Patent Application Publication
(10) Pub. No.: US 2002/0054465 A1
(43) Pub. Date: May 9, 2002

(54) Internally panel-mounted surge protector

(75) Inventor: Michael J. Gerlach, Riverview, FL (US)

Correspondence Address: Donald S. Showalter, Holland & Knight LLP, Suite 1300, One East Broward Blvd., Ft. Lauderdale, FL, 33301, US

(73) Assignee: Advanced Protection Technologies, Inc.

(21) Appl. No.: 09/960,052

(22) Filed: Sep. 20, 2001

Related U.S. Application Data
(60) Provisional application No. 60/233,966, filed on Sep. 20, 2000.

(51) Int. Cl. H02H 3/22

(52) U.S. Cl. 361/111

(57) ABSTRACT

A method and apparatus for surge protecting an electrical load coupled to an AC power distribution system of the type including a distribution panel containing at least one branch circuit overcurrent interrupter. The load is coupled to a surge protection circuit contained within a housing mountable entirely inside the panel. The circuit generates a signal indicative of an operating condition of the circuit. That signal is carried to an externally viewable visual indicator by way of an electrical path which is coupled between the circuit and the indicator and can be physically located entirely within the interior of the distribution panel.

This application claims priority under 35 U.S.C. §119(e) to U.S. Provisional Patent Application Ser. No. 60/233,966 filed Sep. 20, 2000 which is expressly incorporated herein by reference in its entirety to form part of this application.

### FIELD OF THE INVENTION

The invention relates to the field of protecting alternating current (AC) power distribution systems and loads connected thereto from being damaged and/or creating a fire or electrical hazard upon being subjected to over-voltage conditions. More particularly, the present invention relates to an economical and effective surge suppression apparatus and method which can be deployed either internally or externally of a typical residential power distribution panel and which, in a preferred form, provides for a convenient and easily installable visual indicator by which its operational integrity can immediately be confirmed without having to open the panel.

### BACKGROUND OF THE INVENTION

Surge protectors are used in a wide variety of commercial and consumer applications to protect AC power distribution systems and various types of electrical and electronic equipment that receive operating power from such systems. AC power distribution systems and the electrical loads that receive power from such systems can be subjected, often repeatedly, to a potentially damaging and/or hazardous condition commonly referred to as a “power surge.” A power surge is characterized by a sudden and dramatic transient increase in the magnitude of voltage one would normally expect to encounter at a given point in the AC power distribution system. Typically caused by lightning strikes or equipment failures of some kind, power surges can damage or destroy electrical insulation systems as well as motors, switches, control devices, computer systems, and all other types of electrical or electronic equipment. Moreover, such damage may result in fire and/or electrical shock hazards capable of causing death, serious injury, and/or ancillary property damage extending beyond the limits of the electrical system or equipment subjected to the power surge.

In order to prevent or mitigate the effects of power surges, various types of surge protectors are well known. Surge protectors typically include one or more devices commonly referred to as transient voltage surge suppressors (TVSSs), or more recently, as surge protection devices (SPDs). As used herein, the term “surge protection device” is to be construed broadly to refer to any type of device which, in normal operation, exhibits a relatively high electrical impedance, but which, upon being subjected to a voltage of sufficiently high magnitude, exhibits a significantly lower impedance and conducts electrical current relatively readily. Non-limiting examples of various types of SPDs include varistors, silicon avalanche diodes, zener diodes, selenium cells, gas discharge tubes, and high voltage capacitors, of which, the metal oxide varistor (MOV) is favored for many low voltage applications, such as in AC power distribution systems having normal, nominal operating voltages of about six hundred volts AC (600 VAC) or less.

In addition to SPDs, surge protectors may optionally include one or more thermal or overcurrent protectors. As used herein, the term “thermal protector” is to be construed broadly to refer to any type of device which, in normal operation, exhibits a relatively low electrical impedance, but which, upon being subjected to temperatures above a temperature threshold, exhibits a significantly higher impedance and substantially prevents the flow of electrical current. Non-limiting examples of various types of thermal protectors include thermal fuses, bimetal thermostats, thermal cutoffs, thermal cutouts, and thermal links.

Thermal protectors are constructed and function in a variety of ways. In some implementations, a mechanically biased element, such as a spring or flexed piece of metal, is soldered to one end of the device to be protected (e.g. an SPD). When the protected device heats up to a melting temperature of the solder, the solder melts and the biased element recoils or reverts back to its unbiased state, opening the circuit path and abating overheating of the protected device. One such thermal protector, a flexed piece of metal, is described in U.S. Pat. No. 5,790,359. Another such thermal protector, a “MICROTEMP” thermal fuse that is commercially available from Therm-O-Disc, Inc. of Mansfield, Ohio is mentioned briefly in U.S. Pat. No. 5,621,602.

In other thermal protector implementations, such as bimetal thermostats, a bimetallic composite is thermally coupled to one of the devices to be protected. The composite is fabricated by integrally bonding together sheets of two metals (hence the name ‘bimetal’) characterized by differing coefficients of thermal expansion. As the protected device heats up, the bimetal bends due to the interaction of the two pieces of metal expanding at different rates. Upon the protected device reaching a temperature threshold, the composite piece of metal bends sufficiently to open the circuit. Although providing some thermal protection, bimetal thermostats only temporarily open the circuit because as the protected device cools (e.g., after the circuit has been opened for a short length of time), the bimetal also cools and is restored to its original position, thereby once more permitting current flow.

Prior art surge protectors are typically fairly large and bulky. As a consequence, they cannot be mounted within the unused space available in a typical power distribution panel which houses the branch circuit overcurrent interrupters (typically circuit breakers or less commonly, fuses) used in a typical residential or light commercial installation. Instead, surge protectors have been typically mounted in a separate enclosure mounted in the vicinity of the distribution panel and connected thereto by leads running through a conduit offering mechanical protection. Mounting a separate enclosure to house the surge protector entails not only the cost of the enclosure, conduit and associated mounting hardware and fittings but also significant installation costs. Locating sufficient space to mount the surge suppressor enclosure in reasonably close proximity to the distribution panel can often be difficult. If sufficient space is not available, mounting the surge protector panel too far from the distribution panel not only adds further wiring and installation cost but can also degrade or even completely compromise the intended functioning of the surge protector. Even under the best of installation circumstances, the separate enclosure mounted externally of the distribution panel tends to be unsightly.

Surge protectors which mount at least partially within a distribution panel are known in the prior art. A distribution panel which includes such a surge protector equipped with a visual indicator for verifying the operational status of the surge protector circuit is available from Siemens Canada Limited of Mississauga, Ontario under the designation Sentron® TPS-4. Such surge protectors mount in a manner similar to a circuit breaker, directly to the bus bars within the distribution panel. Consequently, the surge protector occupies space on the bus bars which otherwise would have been available for additional circuit breakers. Also, once installed on the bus bars, the face of such prior art surge protectors, including the visual indicator, is visible through a rather large opening specifically formed in the cover of the distribution panel at a predetermined location during manufacture of the cover. Surge protectors of this type however can be installed only in distribution panels having a cover opening of that particular predetermined size and location as well as bus bar mounts of the particular type attachable to corresponding lugs on the surge protector. Thus, prior art surge protectors of this type are suitable mainly for use in new installations in which the special distribution panel they require can be specified. They are not well suited to retrofit applications in since they do not provide a surge protection apparatus or method which can be used with any of a diverse variety of type of distribution panels which are already installed in the field but which lack surge protection. Also, since the face of the surge suppressor which bears the visual indicator is fully or substantially exposed through the special matching opening in the cover of the distribution panel, prior art such as protectors of the type just mentioned do not afford the additional physical isolation and safety of a surge suppressor of the invention, the circuitry of which as will be described, in addition to being enclosed within its own housing, is also enclosed within the distribution panel itself after installation.

Accordingly, there is a need for a surge suppression apparatus and method which can be deployed internally of a typical residential distribution panel as an alternative to being deployed in a separate auxiliary enclosure and can be used with distribution panels of a wide variety of types from any of a variety of manufacturers.

There is further a need for a surge suppression apparatus and method having the advantages just mentioned and which also enable one to readily confirm its operational readiness without having to remove the cover of the distribution panel or other enclosure in which it is deployed.

### SUMMARY OF THE INVENTION

The invention meets the foregoing needs by providing a surge protection method and apparatus that it can be deployed within the available open space of a conventional residential electrical distribution panel and thus, does not require an auxiliary enclosure outside the distribution panel to provide containment, support and mechanical protection. However, if necessitated by circumstances of a particular situation, the apparatus of the invention can alternatively be installed in an auxiliary panel coupled to the distribution panel by way of a nipple or length of conduit. In a preferred embodiment, a surge suppression circuit employing surge protective devices such as thermally protected metal oxide varistors (TPMOVs) enables compact implementation without compromising performance, quality or safety and generates a signal correlated to an operating condition of the circuit.

The invention provides a visual indicator which can be viewed externally of the distribution panel or other enclosure in which the surge protector is deployed. The aforementioned signal is used to drive an indicator to provide a visual indication of the operating condition of the circuit from a location visible exterior of the distribution panel. The signal is conducted to the visual indicator by way of an electrical path which can be located entirely inside the distribution panel. In the preferred embodiment, the indicator, which may suitably comprise an inexpensive but long-lasting light emitting diode (LED), is mounted through an opening in the wall of the enclosure preferably through its cover. The opening can easily be drilled otherwise formed in the field in any suitable location selected by the installer and need only be large enough to accommodate the LED and associated mounting hardware. To facilitate installation as well as replacement of the indicator and subsequent removal of the cover of the distribution panel for installation servicing or inspection of overcurrent interrupters or interior wiring, a detachable electrical connector is preferably interposed in the electrically conductive path between the indicator and the circuit. In the preferred embodiment, the visual indicator is coupled to the circuit of the surge protector through a plug or similar detachable electrical connector which engages a mating receptacle which is preferably disposed inside the housing of the surge protector.

These and other objects and advantages of the invention will become even more apparent to those of ordinary skill in the art upon review of the following detailed written description of a preferred embodiment of the invention taken in conjunction with the appended drawings which together set forth the best mode contemplated by the inventor for carrying out the invention.

### BRIEF DESCRIPTION OF THE DRAWINGS

FIG. 1 is a schematic diagram illustrating a preferred embodiment of a surge protector according to the present invention;

FIG. 2 is a front view of the surge protector module shown in FIG. 1 with the cover of the module removed to better show the internal construction of the module;

FIG. 3 is a side view of the module shown in FIG. 3 with the cover of the module installed;

FIG. 4 is a front view of the surge protector module of FIG. 2 illustrating the mounting of same within an auxiliary enclosure with the cover of the auxiliary enclosure not shown;

FIG. 5 is an end view of the cover of the auxiliary enclosure of FIG. 4 illustrating a typical mounting of the visual indicator shown in FIG. 1.

FIG. 6 is a front view of the auxiliary enclosure of FIG. 4 with the cover of FIG. 5 installed;

FIG. 7 is a front view illustrating a surge protector according to the invention mounted in an auxiliary enclosure external to a typical distribution panel, the removable cover of the distribution panel being shown partially cut away to illustrate wiring connections inside the distribution panel;

FIG. 8 is a flowchart illustrating the method of the invention;

FIG. 9 is a front view illustrating a surge protector installed internally of a distribution panel in accordance with the method of the invention, the removable cover of the distribution panel being shown partially cut away to illustrate wiring connections; and

FIG. 10 is a partial cut away side view further illustrating the mounting of the visual indicator to the distribution panel as shown in FIG. 9.

### DETAILED DESCRIPTION OF A PREFERRED EMBODIMENT

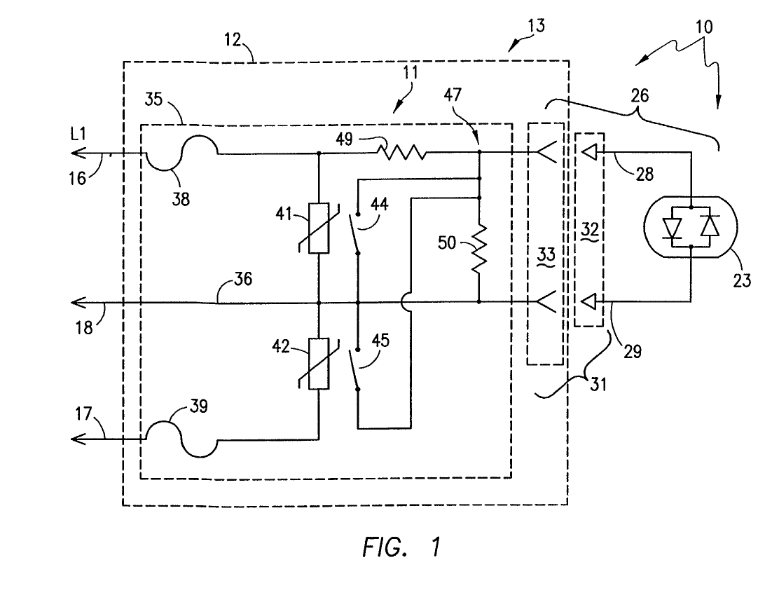

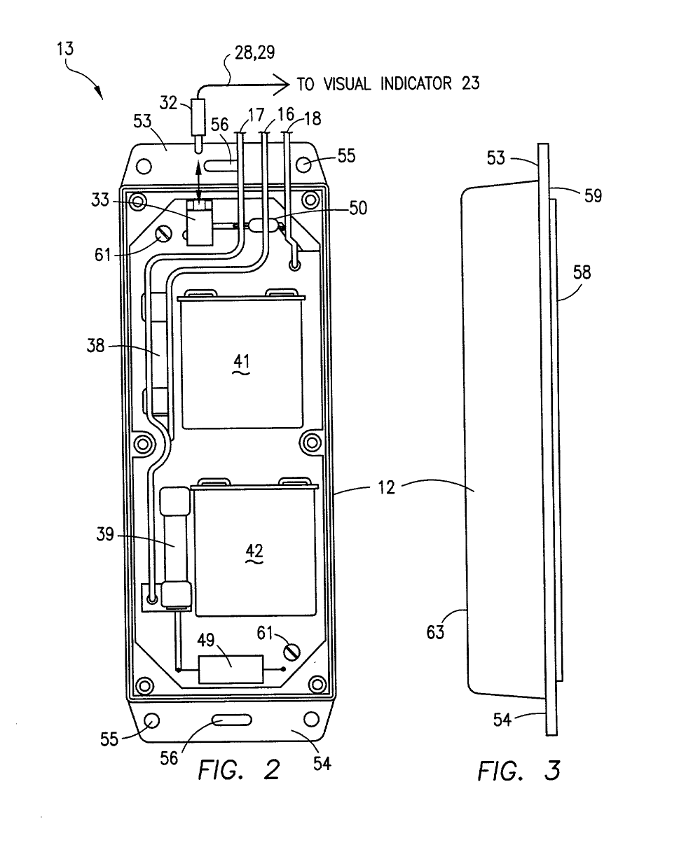

A surge protector 10 according to a preferred embodiment of the invention is illustrated in FIG. 1. Surge protector 10 includes a surge protection circuit 11 enclosed within a housing 12 to form a physically compact module 13. The construction of module 13 will be described in further detail below with reference to FIGS. 2 and 3. An AC power distribution system supplying an electrical load to be protected us coupled to circuit 11 by way of a series of appropriately color-coded, stranded copper wire leads extending from housing 12. For a typical 120/240 VAC protection circuit, those leads include a first line lead 16, a second line lead 17 and a ground/neutral lead 18, each preferably about two to four feet in length prior to installation.

Surge protector 10 also includes a visual indicator 23 which operates to provide a visual indication of at least one operating condition of circuit 11. While visual indicator 23 may suitably comprise any form of visual indicator including without limitation an alpha-numeric display interfaced via a conventional display driver/decoder (not shown) or one or more incandescent or gas-discharge lamps, visual indicator 23 preferably comprises a long life A.C. LED of a readily visible and appropriate color such as green to indicate when circuit 11 is energized and operating properly. If desired, the logic could readily be inverted and a visual indicator 23 in a color such as orange or red provided to be energized only in the event of a malfunction. However, such an inverted logic implementation is not preferred since disconnection of power or failure of visual indicator 23 itself would not be readily indicated.

Visual indicator 23 is located outside housing 12 for installation in a location up to several feet or more remote from module 13. To facilitate such remote installation, visual indicator 23 is coupled to circuit 11 by way of an electrical path 26. In the preferred embodiment, electrical path 26 includes a pair of insulated, stranded copper wires 28 and 29 which are preferably each about two to four feet as supplied but which may be trimmed to length as appropriate to a particular installation. According to an optional but preferred aspect of the invention, electrical path 26 also includes a detachable electrical connector 31 interposed therein. In a preferred form, connector 31 has a plug 32 which is selectively mateable to a corresponding socket 33 so as to render electrical path 26 electrically and mechanically continuous when plug 32 is mated to socket 33 and conversely, to render electrical path electrically and mechanically discontinuous when plug 32 is detached from socket 33.

Surge protector circuit 11 is preferably mounted on a printed circuit board 35, mounted inside housing 12 and includes a ground conductor 36 which connects ground/neutral lead 18 to one side of socket 33 and in turn, to the ground side of visual indicator 23 by way of plug 32 and wire 29. The line sides of a pair of fuses 38 and 39 are connected in series with first line conductor 16 and second line conductor 17, respectively. The load sides of fuses 38 and 39 are each shunted to ground conductor 36 by way of a respective surge protection device (SPD) such as (MOVs) metal oxide varistors 41 and 42. As those skilled in the art will appreciate, any known type of SPD can readily be substituted for MOVs 41 and 42, including without limitation, any of the various types of SPDs mentioned earlier in this document. Optionally, MOVs 41 and 42 may be provided as part of devices which include integral, normally-open thermal protective switches 44 and 45, respectively.

As shown in FIG. 1, one side of each thermal protector 44 and 45 are connected together in common with ground conductor 36. The opposing sides of thermal protectors 44 and 45 are each connected to a node 47 located in the midst of a voltage divider formed by a pair of resistors 49 and 50. Resistor 49 serves as a current limiter and is connected between node 47 and the load side of fuse 38. Resistor 50 is connected between node 47 and ground conductor 36. The physical layout and construction of module 13 will now be described with reference additionally to FIG. 2 and FIG. 3.

Housing 12 may be formed of stamped or drawn metal such as aluminum or steel but is more preferably injection molded of a suitable electrically insulating, flame resistant, thermoset or thermoplastic material. Housing 12 is preferably made of a 94-V5 flameproof material and is of a type listed by Underwriters Laboratories, Inc. for installation inside a distribution panel. In the preferred embodiment, housing 12 includes a pair of mounting ears 53, 54 each of which is penetrated by one or more holes 55 and/or slots 56 capable of accommodating self-tapping sheet metal screws or other fasteners (not shown). As an alternative mounting option, a strip of double-sided, pressure sensitive, foam tape may be adhered to the rear face 59 of housing 12. Printed circuit board 35 is secured to the bottom of housing 12 by one or more screws 61 and spaced therefrom by standoffs (not shown). Soldered to printed circuit board 35 at locations as shown are fuses 38 and 39, MOVs, 41 and 42, resistor 49 and resistor 50. As shown, leads 16, 17 and 18 are also soldered to printed circuit board 35 and extend from housing 12 through an opening (not shown) formed in a wall thereof. Socket 33 is mounted on printed circuit board 35 directly in line with a second small opening (not shown) through which plug 32 may be either inserted into socket 33 or detached from socket 33. Housing 10 is provided with a lid 63 which, except for the openings provided for plug 32 and leads 16, 17 and 18, serves to fully enclose circuit 10 within housing 12 when lid 63 is installed. Preferably, module 13 is designed and tested in accordance with the applicable sections of at least the following standards: ANSI/IEE C62.41; ANSI/IEEE C62.45; UL 50; UL 1449 Second Edition; cUL (Canadian Reciprocal Standard for TVSS devices); NFPA 70 (NEC) (National Fire Protection Association National Electrical Code. A typical design operating temperature range would be −5° C. to 45° C. at relative humidities ranging between 1 and 95%. Before the operation of surge protector 10 is explained in further detail, two alternative methods of installation of surge protector 10 will first be described.

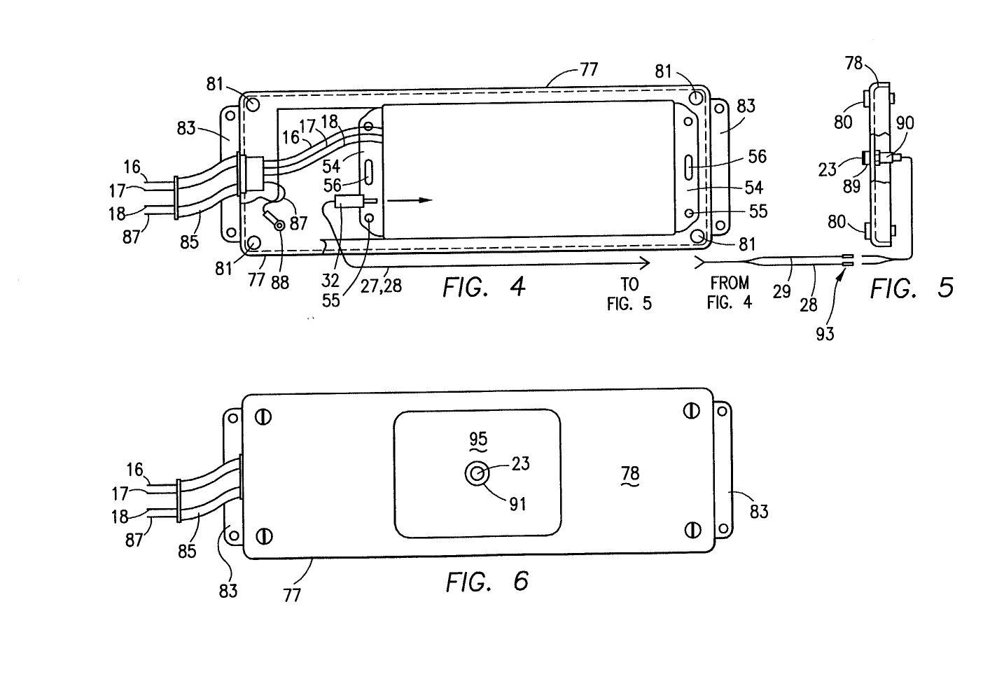

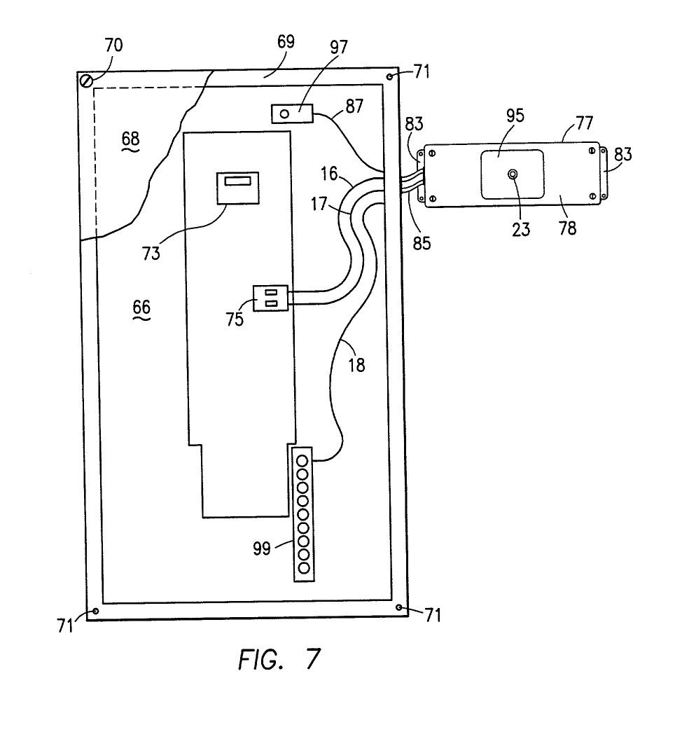

FIGS. 4 through 7 together illustrate a method of installing surge protector 10 with module 13 housed exteriorly of a branch circuit distribution panel 66. A typical residential or light commercial alternating current power distribution system typically includes at least one branch circuit distribution panel 66 having a removable cover 68 securable to a peripheral flange 69 by one or more screws 70 receivable in holes 71 provided in flange 69. Distribution panel 66 may include a main circuit breaker 73 or main fuse module (not shown) and generally includes at least one single pole or double pole branch circuit overcurrent interrupter 75. Branch circuit overcurrent interrupters 75 may suitably comprise fuses but more commonly take the form of circuit breakers, a two-pole 120/240 volt circuit breaker is shown as a non-limiting example in FIG. 7. Auxiliary enclosure 77 having a removable lid 78 which may be secured in place by screws 80 receivable within bosses or threaded inserts 81 associated with the body of auxiliary enclosure 77. Enclosure 77 may also be provided with mounting flanges 83 to permit enclosure 77 to be firmly secured to a wall or other surface. Enclosure 77 is fitted with a conduit, such as an offset nipple 85, which serves to protect the leads 16, 17 and 18 extending from module 12 as well as a bonding jumper 87 an end of which is electrically and mechanically connected to auxiliary enclosure 77 itself by way of a ring terminal 88.

Visual indicator 23 is encased in a mounting bezel 89 having a threaded projection 90 which is received within an opening formed in lid 78. A lock nut 91 is attached to threaded projection 90 to secure bezel 89 and thus visual indicator 23 securely to cover 78. The free ends of leads 28 and 29 extending from plug 32 are trimmed to length as desired and are electrically coupled to visual indicator 23 using a pair of insulated crimp terminals 93 and indicated in FIG. 5, plug 32 is then inserted into socket 33 and cover 77 installed on auxiliary enclosure 77 using screws 80 so that, as shown in FIG. 6, visual indicator 23 will be clearly visible from a location exteriorly of auxiliary enclosure 77. Optionally, visual indicator 23 may be surrounded by a pressure-sensitive label 95 adhesively secured to cover 78 and bearing appropriate indicia such as a shock hazard warning and/or instructions indicating module 12 should be replaced in the event visual indicator 23 is no longer lighted.

Once module 12 has been mounted inside auxiliary enclosure 77, an AC voltmeter is used to confirm that line to neutral voltages within distribution panel 66 are 120 volts each and line-to-line voltage is 230 volts. Bonding of ground and neutral is also confirmed. Circuit breaker 73 is then switched off and locked out for safety before proceeding further. With distribution panel 66 de-energized, auxiliary enclosure 77 may be coupled to distribution panel 66 by way of nipple 85 and is secured to the wall or other surface adjacent distribution panel 66 by means of suitable fasteners (not shown) penetrating mounting flanges 83. Final wiring connections are then made by first connecting bonding jumper 87 to a ground lug 97 within distribution panel 66 and connecting ground/neutral lead 18 to the neutral bar 99 of distribution panel 66. Thereafter, first and second line leads 16 and 17, are trimmed to length and electrically connected to respective line sides of the alternating current power distribution system. This is preferably done by connecting leads 16 and 17 to the load side of a two-pole branch circuit overcurrent protector 75 as shown. For best performance, leads 16 and 17 are preferably twisted around one another to form a double helix prior to being connected to branch overcurrent protector 75. After checking all wiring connections, the cover 68 of distribution panel 66 is installed. Thereafter, main circuit breaker 73 as well as overcurrent interrupter 75 are energized. Upon energization, visual indicator 23 will light indicating that surge protector 10 is operating.

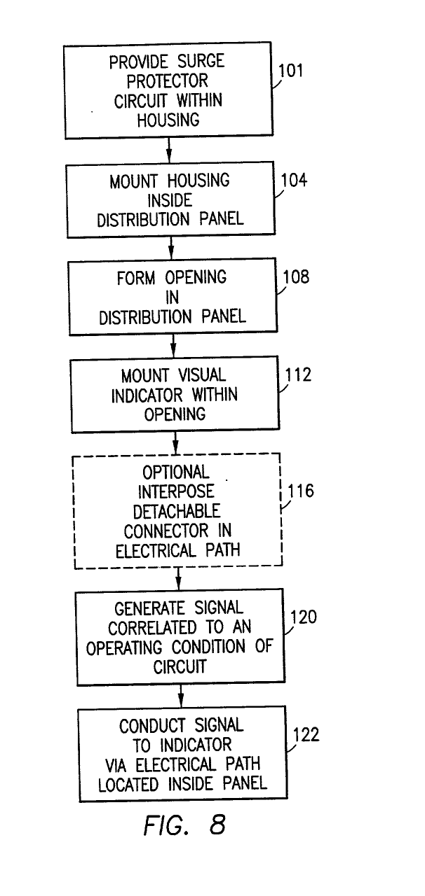

Installation of surge protector 10 within an auxiliary enclosure 77 located outside distribution panel 66 as just described may be necessary in the event distribution panel 66 is too small or crowded to accommodate module 13 inside distribution panel. Preferably, however, surge protector 10 is installed in accordance with the method of the invention as will now be described referring additionally to FIGS. 8, 9 and 10.

A surge protector circuit 11 disposed within housing 12 is provided as indicated at step 101. This step may suitably be carried out by providing module 13, the circuitry and construction of which were described in detail above with reference to FIGS. 1, 2 and 3. With the removable cover 68 of distribution panel 66 removed, line-to-line voltage and bonding of ground and neutral are first confirmed. Then, with main circuit breaker 73 de-energized and locked out for safety, housing 12, with circuit 11 enclosed therein is mounted 104 inside distribution panel 66. Mounting step 104 may readily be carried out by using double-sided tape 58 to adhere the rear face 59 of housing 12 to an internal side wall of distribution panel 66. Alternatively, housing 12 may be secured to distribution panel 66 by screws or other fasteners (not shown) passing through the holes 55 and/or slots 56 of mounting ears 53 and/or 54. Regardless of the exact location or mounting technique used, housing 12 is mounted such that after cover 68 is re-installed, the housing 12 enclosing circuit 11 is located entirely inside distribution panel 66.

In order to accommodate visual indicator 23, an opening 106 is formed 108 in distribution panel 66. Opening 106 is preferably formed in the removable cover 68 of distribution panel 66 though it may alternatively be located in any exterior wall of distribution panel 66 offering a good view of visual indicator 23 in a particular installation. Opening 106 may be formed 108 by any suitable technique such as drilling, cutting or punching with care being taken not to contaminate the interior of distribution panel 66 with metallic pieces or shavings. It will be noted that forming step 108 need not be carried out after step 101 or step 104 but may be carried out prior to either or both of steps 101 and 104. Indeed, otherwise indicated, neither FIG. 8 nor the order of steps as recited in the appended claims are to be construed as limiting the method of the invention to any particular sequence of steps.

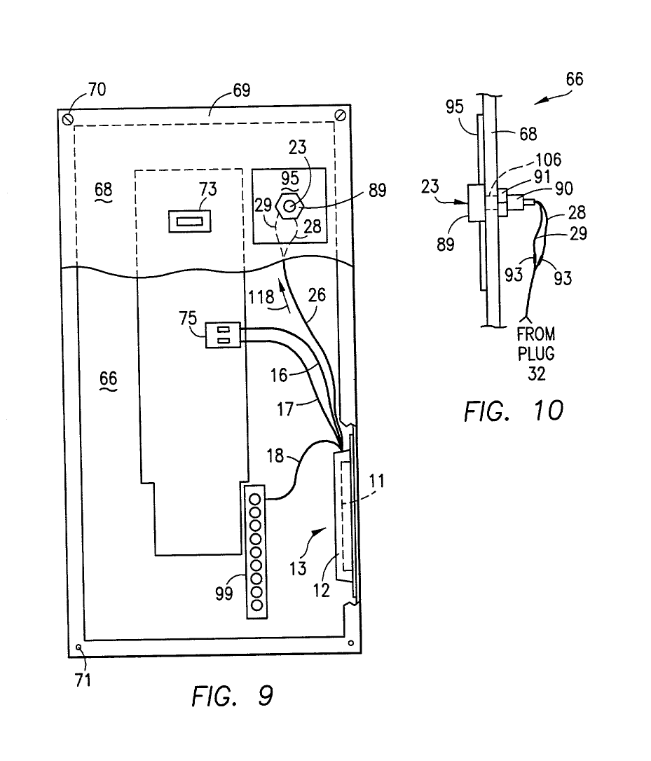

Visual indicator 23 is mounted 112 within opening 106 so as to be capable of providing a visual indication visible from a location outside distribution panel 66 when the cover 68 of distribution panel 66 is installed. To carry out mounting step 112 in the preferred embodiment, threaded projection 90 is passed through opening 106 and lock nut 91 is threaded onto projection 90 to secure visual indicator 23 in place with its mounting bezel 89 retained by the exterior surface of cover 68. Wires 28 and 29 are then electrically connected to visual indicator 23 by way of terminals 93. First and second line leads 16 and 17 are then trimmed to length, twisted around one another to form a double helix over substantially their entire remaining length and are connected to the load sides of a two-pole branch circuit overcurrent interrupter 75. Ground/neutral lead 18 is connected to neutral bar 99 as shown in FIG. 9. Optionally, a label 95 bearing indicia as described above may be secured to the exterior surface of cover 68 in the vicinity of visual indictor 23.

As described earlier, the electrical path 26 between circuit 11 and visual indication, optionally but preferably has interposed 116 therein a detachable electrical connector 31. Connector 31 includes socket 33 as well as plug 32 which is selectably mateable with socket 33 to render electrical path 36 electrically and mechanically continuous as requested when surge protector 10 is in operation. However, to facilitate subsequent removal and reinstallation of cover 68 as well as to facilitate replacement of visual indictor 23 or module 12 if later required, electrical path 26 may readily be rendered both electrically and mechanically discontinuous by simply detaching plug 32 from socket 33.

When installation of surge protector 10 has been completed and wiring connections checked, main circuit breaker 73 and branch circuit overcurrent interrupter 75 are energized to commence operation of surge protector 10. When operating in accordance with the method of the invention, a signal 118 correlated to an operating condition of circuit 11 is generated 120. Signal 118 is conducted 122 to visual indicator 23 by way of electrical path 26, the entirety of path 26 being located inside distribution panel 66 when its cover 68 is installed. Steps 120 and 122 as carried out in accordance with the preferred embodiment, will now be described in further detail by explaining the operation of surge protector 10 in further detail.

In operation, surge protector 10 not only protects the alternating power distribution system to which it is connected from abnormal conditions, but as just noted, also generates signal 118 correlated to the operating condition of surge protector circuit 11. Signal 118 is conducted 122 to visual indicator 23 to provide a visual indication of an operating condition of circuit 11. In the preferred embodiment, absence of that visual indication alerts a user that surge protector 10 may not be carrying out is protective function. In accordance with the invention, the electrical path 26 which conducts signal 118 to visual indicator 23 to provide the externally visible indication of the operating condition is located entirely within distribution panel 66. No auxiliary enclosure 77 is needed and safety is enhanced since the surge protector 10 is fully enclosed within the panel and none of the wiring connections between surge protector 10 and the distribution panel 66 pass through or extend outside any wall of distribution panel 66.

In normal operation, when main circuit breaker 73 and overcurrent interrupter 75 are energized, first and second line leads 16 and 17 are energized at 120 VAC with respect to ground and at 240 VAC with respect to one another. This is the normal U.S. residential electrical or light commercial distribution voltage system sometimes referred to as “split phase”. The operational condition of the circuit 11 is indicated by visual indicator 23. When the visual indicator 23 is illuminated, module 13 is functioning properly and is protecting the electrical distribution panel 66 to which it is connected. Fuses 38 and 39 will open in the event of an overcurrent condition associated with surge protector 10 thus protecting leads 16 and 17. Metal oxide varistors 41 and 42 each act like an open circuit (i.e. high resistance) at normal system voltages. The voltage divider formed by resistors 49 and 50 generate electrical signal 118 at node 47. Signal 118 is generated by current flowing from first line lead 16 through fuse 38, current limiting resistor 49 and through visual indicator 23 via electrical path 26 to ground. Signal 118 is conducted to visual indicator 23 by way of electrical path 26 which preferably includes a detachable electrical connector 31 therein. As long as circuit 11 is energized and operating normally, visual indicator 23 is energized by signal 118 and remains illuminated.

A high transient voltage entering distribution panel 66 will be conducted to ground through the operation of module 13. When subjected to abnormally high voltages, MOVs 41 and 42 present a low resistance path to ground/neutral lead 18 from first line lead 16 through fuse 38 through MOV 41 or alternatively, from line second line lead 17 through fuse 39 through MOV 42. Under such abnormally high voltage conditions the MOVs 41 and 42 exhibit a significantly lower resistance than at normal line voltages and act to maintain the transient line to line and line to ground voltage at magnitudes low enough to prevent damage to branch circuit loads which may be connected to the distribution panel 66 via the one or more branch circuit overcurrent interrupters also mounted inside panel 66.

Under abnormal sustained over-voltage conditions, MOVs 41 and/or 42 enter a lower resistance state and overheat. A leaf spring inside the thermally protected MOV 41 and/or 42 disconnects it from the circuit and allows closure of normally open thermal protective switches 44 and/or 45. When switch 44 and/or 45 closes, node 47 and thus, visual indicator 23 is shorted. Signal 118 is then no longer generated. Consequently, visual indicator 23 is de-energized and its visual indication extinguished. Switches 44 and 45 are connected electrically in parallel so that the opening of either or both of them de-energizes visual indicator 23. Fuses 38 and 39 are optional but are recommended. When used, fuses 38 and 39 should be of a type conforming to all applicable sections of UL standard 1449 which is the standard relating to transient voltage surge suppressor products. Opening of either or both fuses 41 and 42 also causes visual indicator 23 to be extinguished thus alerting a user that surge protector 10 may not be operating normally. MOVs 41 and 42 are preferably of a type which have been shown to open when exposed to short-circuit ranging from ⅛ AMP to 100,000 AMP's.

Table 1 attached sets forth a detailed parts listing for the preferred embodiment just described.

TABLE 1

| Reference | | | | |
|---|---|---|---|---|
| Numeral | Quantity | Description | Manufacturer or Source | Manufacturer's Part Number |
| 41, 44, | 2 | 150TPMOV thermal 40 mm MOV | Ferraz-Shawmut (Gould) | 150TPMOV |
| 42, 45 | | | | |
| 38, 39 | 2 | APT100 10 KA, 600 V, 200 KAIC | Ferraz-Shawmut (Gould) | APT100 |
| | | FUSE | | |
| 12 | 1 | Plastic enclosure 6.5″ by 2.8″ by | Hammond Manufacturing Co., | 1591HFLBK Dupont Rynite ® |
| | | 1.16″ Platinum Grey color/GE | Inc. | PET thermoplastic polyester, |
| | | Valox ® 780 plastic | | polycarbonate such as GE Valox ® |
| | | | | or ABS such as CHI-MEI part |
| | | | | number PA-765 |
| 23 | 1 | Panel mount green AC LED | Lumex | SSI-LXR1612GGDQ3258 |
| 35 | 1 | Printed circuit board | Axon | N/A |
| 49 | 1 | Resistor 10K ohm, 5 W 5% cement | Mouser/Xicon | 28PR004-10K |
| | | power | | |
| 50 | 1 | Resistor 620 ohm, ¼ W listed | Mouser/Xicon | 291-620 |
| 18 | 1 pc. 3 ft | Green wire 10 AWG, 600 V, UL | Graybar THHN 600 V UL | THHN-10-STR Green |
| | | listed | | |
| 16, 17 | 2 pcs. 3 ft | Black wire 10 AWG, 600 V, UL | Graybar THHN 600 V UL | THHN-10-STR Black |
| | each | | | |
| 33 | 1 | DC power jack | RDI | RDJ-005B |
| 32 | 1 | DC power cord 2.5 mm plug, 22 | RDI | DC10B |
| | | AWG | | |
| 95 | 1 | Label, panelboard trim | | |
| 93 | 2 | 3M Scotchblock ® 22-16 AWG | 3M Scotchblock ® type 557 | 314 |
| | | UL approved | | |
| 58 | 4 | Double side sticky tape (UL746C | 3M | VHB 4951 45 mil foam tape |
| | | listed) | | 1″ wide × 2″ long |
| 77 | 1 | 10¼″ × 3¼″ × 2¾″ | Robroy/Stahlin | CF1144 |
| | | Figerglass Box | | |
| 85 | 1 | Offset ½″ Nipple | Graybar | 6A2 |

While the foregoing constitute certain preferred and alternative embodiments of the present invention, it is to be understood that the invention is not limited thereto and that in light of the present disclosure various other embodiments will become apparent to persons skilled in the art. Accordingly, it is to be recognized that changes can be made without departing from the scope of the invention as particularly pointed out and distinctly claimed in the appended claims which shall be construed to encompass all legal equivalents thereof.

What is claimed is:

1. An apparatus for surge protecting an electrical load connected to an alternating alternating current power distribution system of the type including a distribution panel having a removable cover and containing at least one branch circuit overcurrent interrupter, said apparatus comprising:
a housing mountable entirely inside of the distribution panel;
a surge suppression circuit disposed inside said housing, said circuit being electrically coupleable to the load and operable to generate an electrical signal correlated to an operating condition of said circuit;
a visual indicator mounted to the distribution panel for providing a visual indication of said operating condition in response to said signal, said indicator being mounted to render said indication visible from a location outside the distribution panel when the cover of the distribution panel is installed, and
an electrical path coupling said circuit to said indicator for carrying said signal to said indicator, said path being located entirely inside of the distribution panel when the cover of the distribution panel is installed, at least a portion of said path being located outside said housing.

2. The apparatus of claim 1 wherein said visual indicator is mounted to the removable cover of the distribution panel.

3. The apparatus of claim 1 further comprising:
a detachable electrical connector interposed in said electrical path, said connector having a socket and a plug selectively attachable to said socket to render said path electrically and mechanically continuous, said plug being detachable from said socket to render said path electrically and physically discontinuous.

4. The apparatus of claim 3 wherein at least one of said plug and said socket is located at least partially interiorly of said housing.

5. A method for surge protecting an electrical load connected to an alternating current electrical power distribution system of the type including a distribution panel having a removable cover and containing at least one branch circuit overcurrent interrupter, said method comprising the steps of:
providing a surge protector circuit disposed within a housing;
mounting said housing entirely inside the distribution panel;
forming an opening in the distribution panel;
mounting a visual indicator within said opening so as to be capable of providing a visual indication visible from a location outside of the distribution panel when the cover of the distribution panel is installed;
generating an electrical signal correlated to an operating condition of said circuit, and
conducting said signal to said visual indicator by way of an electrical path located entirely inside of the distribution panel when the cover of the distribution is installed to provide said visual indication, at least a portion of said path being located outside said housing.

6. The method of claim 5 wherein said forming step comprises the step of forming said opening in the cover of the distribution panel.

7. The method of claim 5 further comprising the step of:
interposing in said electrical path a detachable electrical connector of the type having a socket and a plug selectively matable with said socket to render said path electrically and mechanically continuous said plug being detachable from said socket to render said path electrically and mechanically discontinuous.
